(19) United States
(12) Patent Application Publication
(10) Pub. No.: US 2021/0158266 A1
(43) Pub. Date: May 27, 2021

(54) SYSTEMS AND METHODS FOR AUTOMATING WORKFORCE MANAGEMENT SYSTEMS

(71) Applicant: Talkdesk, Inc., San Francisco, CA (US)

(72) Inventors: Jason Fama, San Carlos, CA (US); Richard Lawrence, San Diego, CA (US)

(21) Appl. No.: 16/696,044

(22) Filed: Nov. 26, 2019

(51) Int. Cl. G06Q 10/06; G06N 5/04

(52) U.S. Cl. CPC G06Q 10/063116; H04M 2203/402; G06Q 10/0633; G06N 5/04

(57) ABSTRACT

An automated WFM system is provided that automates many of the tasks that were previously handled by a user or administrator associated with the system. The system handles forecast and schedule generation, as well as employee (e.g., agent) requests automatically and without any need for input from a user or administrator. The system minimizes the need for a dedicated employee to handle WFM, and only requests input for a user or administrator as a last resort.

### BACKGROUND

The continued use of a contact center workforce management (WFM) system is a typically time-consuming processes for entities such as contact centers. These systems typically include numerous tasks that must be manually completed by an administrator prior to generating forecasts and schedules for an entity. Small entities that are unable to dedicate one or more employees to handle the WFM system may have difficulty taking full advantage of the capabilities of their WFM system.

### SUMMARY

An automated WFM system is provided that automates many of the tasks that were previously handled by a user or administrator associated with the system. The system handles forecast and schedule generation, as well as employee (e.g., agent) requests automatically and minimizes the need for input from a user or administrator. The system eliminates the need for a dedicated employee to handle WFM, and only requests input from a user or administrator as a last resort.

In an embodiment, a method is provided. The method includes: generating a forecast for a plurality of queues associated with an entity for a plurality of intervals by a computing device; determining if the generated forecast passes each forecast test of a plurality of forecast tests for the plurality of queues by the computing device; and if it is determined that the generated forecast passes the plurality of forecast tests for the plurality of queues, generating a schedule based on the generated forecast by the computing device.

In an embodiment, a method is provided. The method includes: receiving a forecast for a plurality of queues associated with an entity for a plurality of intervals by a computing device; generating a schedule for a plurality of employees for the plurality of queues and the plurality of intervals based on the received forecast by the computing device; determining if the generated schedule passes each schedule test of a plurality of schedule tests by the computing device, and in response to determining that the schedule passes each schedule test of the plurality of schedule tests, releasing the schedule to the plurality of employees by the computing device.

In an embodiment, a method is provided. The method includes: generating a forecast for a plurality of queues associated with an entity for a plurality of intervals by a computing device; determining if the generated forecast passes each forecast test of a plurality of forecast tests for the plurality of queues by the computing device; if it is determined that the generated forecast passes each forecast test of the plurality of forecast tests for the plurality of queues, generating a schedule for a plurality of employees for the plurality of queues and the plurality of intervals based on the generated forecast by the computing device; determining if the generated schedule passes each schedule test of a plurality of schedule tests by the computing device, and in response to determining that the schedule passes each schedule test of the plurality of schedule tests, releasing the schedule and the forecast by the computing device.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example system architecture for incorporating a configuration engine into a business or entity such as a contact center;

FIG. 3 is an illustration of an example method for generating and releasing a forecast;

FIG. 4 is an illustration of an example method for generating and releasing a schedule;

FIG. 5 is an illustration of an example method for generating and releasing a forecast and a schedule; and

FIG. 6 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

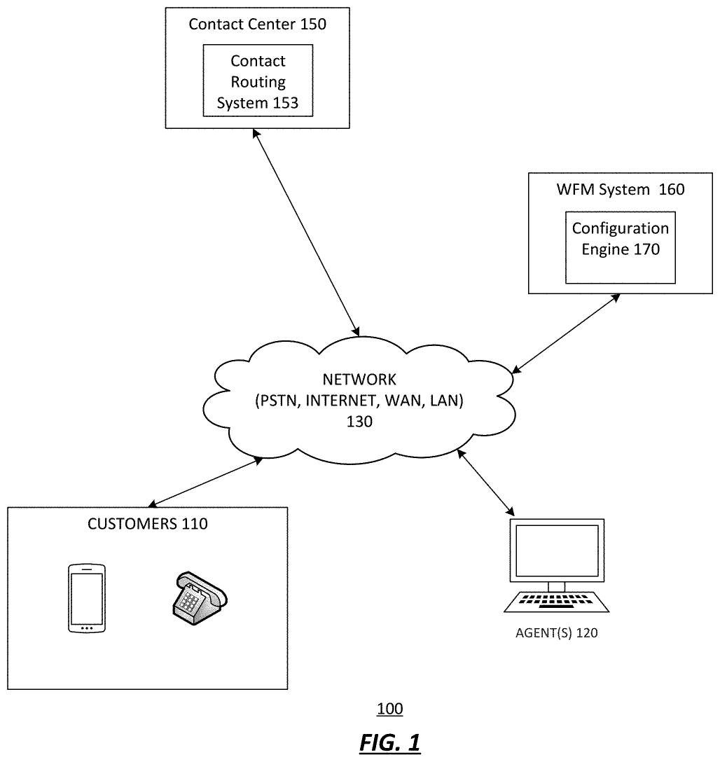

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with the agents 120 through a network 130 and one or more of text or multimedia channels. The system that controls the operation of the contact center 150 including the routing and handling of communications between customers 110 and agents 120 for the contact center 150 is referred to herein as the contact routing system 153. Depending on the embodiment, the contact routing system 153 could be any of a contact center as a service (CCaS) system, an automated call distributor (ACD) system, or a case system, for example.

The agents 120 may be remote from the contact center 150 and handle communications with customers 110 on behalf of an enterprise. The agents 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

In some embodiments, the agents 120 may be assigned to one or more queues. The agents 120 assigned to a queue may handle communications that are placed in the queue by the contact center 150. For example, there may be queues associated with a language (e.g., English or Chinese), topic (e.g., technical support or billing), or a particular country of origin. When a communication is received by the contact center 150, the communication may be placed in a relevant queue, and one of the agents 120 associated with the relevant queue may handle the communication.

The agents 120 of a contact center 150 may be further organized into one or more teams. Depending on the embodiment, the agents 120 may be organized into teams based on a variety of factors including, but not limited to, skills, location, experience, assigned queues, associated or assigned customers 110, and shift. Other factors may be used to assign agents 120 to teams.

Entities that employ workers such as agents 120 typically use a WFM system 160 to schedule agents 120 based on generated workload forecasts. To generate forecasts, the WFM system must take into account information such as upcoming promotions or marketing events and queues that have been newly added or removed from the contact center 150. To generate schedules the WFM systems must take into account information such as local employment laws, time and shift preferences of each agent 120, and the skills of each agent 120, for example.

While WFM systems are useful, using and maintaining such systems including collecting and verifying the information used to generate forecasts and schedules may be a time-consuming task. Accordingly, to solve this problem, the environment 100 further includes a configuration engine 170. As will be described further below, the configuration engine 170 works with the WFM system 160 to automatically collect and verify information that is used to configure the WFM system 160 with respect to forecasting and scheduling such that the need for one or more employees to oversee the configuration of the WFM system 160 is minimized. Note that while the configuration engine 170 is shown as being part of the WFM system 160, it is for illustrative purposes only. The configuration engine 170 may be implemented as part of, or separate from, one or all of the WFM system 160, the contact center 150, and the contact routing system 153.

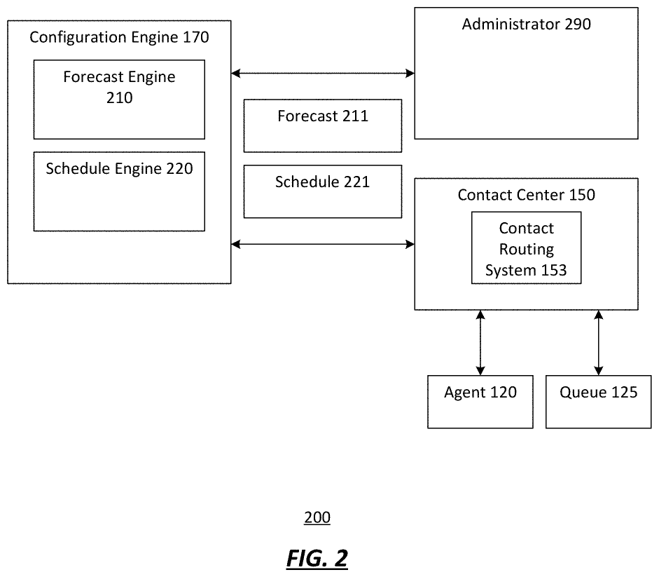

In addition, while the configuration engine 170 is described with respect to a contact center 150, it can be used by any entity that uses a WFM system 160 to generate forecasts and schedules for their employees. The workings of the configuration engine 170 will be described in further detail with respect to FIG. 2.

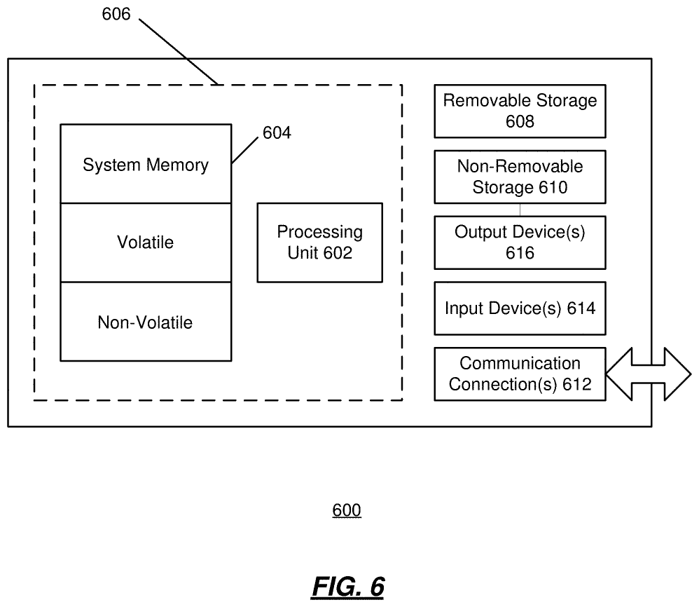

FIG. 2 is an illustration of an example system architecture for incorporating a configuration engine 170 into a business or entity such as a contact center 150. As shown the configuration engine 170 includes various modules and components such as a forecast engine 210 and a schedule engine 220. More or fewer engines, modules, or components may be supported by the configuration engine 170. Depending on the embodiment, each of the forecast engine 210 and schedule engine 220 may be implemented together or separately by one or more general purpose computing devices such as the computing system 600 illustrated with respect to FIG. 6.

The forecast engine 210 may generate a forecast 211 for one or more queues 125 of the contact center 150. A forecast 211 may be associated with one or more upcoming intervals for the contact center 150. Generally, the forecast 211 may predict how busy each of the one or more queues 125 will be during each interval. An interval, as used herein may be the smallest amount of time that can be scheduled for the contact routing system 153. The intervals may be 15 minutes, 30 minutes, 1 hour, etc. Depending on the embodiment, the forecast engine 210 may generate a forecast 211 using historical data about the number of communications that were received by each queue 125 in the past for the same or similar intervals. Any method may be used.

The forecast engine 210 may generate forecasts 211 on a regular or scheduled basis. For example, the forecast engine 210 may generate a forecast 211 every week that includes intervals for the next six months. The frequency at which forecasts 211 are generated, and the number of intervals that are covered by the forecasts 211, may be set by an administrator 290.

The forecast engine 210 may generated forecasts 211 in response to a request. For example, the administrator 290 may request that a forecast 211 be generated for a particular interval or set of intervals. The forecast engine 210 may further generate a forecast 211 in response to detecting or predicting a surge period. Surge periods, and their detection, are described further with respect to U.S. patent application Ser. No. 16/573,040.

In some embodiments, prior to generating a forecast 211, the forecast engine 210 may take certain actions to ensure that the generated forecast is accurate and complete. As one example action, the forecast engine 210 may prompt the administrator 290 to identify any upcoming events that fall within the intervals covered by the forecast 211 that may have an effect on the forecast 211. These events may include marketing promotions and product releases. The prompt may be an electronic communication that is sent from the forecast engine 210 to the administrator 290 such as an e-mail or a text message, for example. Depending on the embodiment, the forecast engine 210 may prompt the administrator 290 to identify upcoming events approximately a week prior to generating the forecast 211. Other time frames may be used.

As another example action, the forecast engine 210 may prompt the administrator 290 to verify that one or more historical volumes (e.g., historical data) that are used to generate the forecast 211 are available and up-to-date. The forecast engine 210 may prompt the administrator 290 to specify which, if any, of the historical volumes are missing or unavailable. The prompt may be an electronic communication that is sent from the forecast engine 210 to the administrator 290. Depending on the embodiment, the forecast engine 210 may prompt the administrator to verify the historical volumes approximately a week prior to generating the forecast 211. Other time frames may be used.

As another example, the forecast engine 210 may determine if any new queues 125 have been added to the contact center 150 by interfacing with the contact routing system 153 (or other system). If there is a new queue 125, the forecast engine 210 may attempt to determine a similar queue 125 based on the communication history of the new queue 125 so far to use for forecasting purposes. Alternatively, or if no similar queue 125 can be determined, the forecast engine 210 may prompt the administrator 290 to identify a similar queue 125. The historical data associated with the similar queue 125 may be used by the forecast engine 210 to generate the forecast 211 for the new queue 215 until enough historical data has been collected about the new queue 125.

Other examples of actions taken by the forecast engine 210 include determining any queues 125 that have been deleted and determining any upcoming holidays. Either or both of these may be determined by the forecast engine 210 interfacing with the contact routing system 153 or by prompting the administrator 290.

After performing the various pre-forecast actions, the forecast engine 210 may generate the forecast 211. The forecast engine 210 may generate the forecast 211 using the historical data from the one or more historical volumes while considering the data collected while performing the pre-forecast actions described above.

After generating the forecast 211, the forecast engine 210 may perform one or more of what are referred to as forecast tests on the generated forecast 211. If the forecast 211 passes all of the forecast tests, the forecast engine 210 may release the forecast 211 to one or more of the administrator 290 and/or the agents 120. In addition, as will be described further below, the generated forecast 211 may be later used by the schedule engine 220 to generate a schedule 221.

The various tests of the forecast tests may function as a sanity test to judge the reasonableness of the forecast 211. One example of such a test is the interaction volume test. The interaction volume test may include ensuring that all of the active queues 125 are predicted to have greater than zero volume, handle time, and patience for each interval of the forecast 211. As may be appreciated, an active queue 125 having zero volume, handle time, and patience for an interval is unusual, and therefore the occurrence of such a zero interval may indicate that there is a problem with the generated forecast 211.

Another example of a forecast test is the confidence interval test. The confidence interval test is based on the confidence interval associated with each time interval of the forecast 211. When the forecast engine 210 generates a forecast 211, each time interval prediction may be associated with a confidence interval that indicates how confident that the forecast engine 210 is with respect to the prediction. The confidence interval test may be that the number of time intervals with confidence intervals less than 95% not exceed some threshold number such as 10 percent per day. The particular threshold may be set by a user or administrator.

In the event that the generated forecast 211 does not pass all of the forecast tests, the forecast engine 210 may prompt the administrator 290 to review the generated forecast 211. The administrator 290 can reject the forecast 211, alter or modify the forecast 211, request that a new forecast 211 be generated, or allow the forecast 211 to be released without modification.

The actions of the administrator 290 may be used as feedback (positive or negative) to one or more of the forecast tests by the forecast engine 210. In particular, the actions may be used to adjust one or more tolerances associated with the forecast rules. For example, if the administrator 290 releases the forecast 211 that failed one or more of the forecast tests, it may indicate that some or all of the forecast tests are too stringent. Accordingly, the forecast engine 210 may adjust the tolerances associated with the confidence interval test by increasing the threshold percentage to 11% from 10% or by decreasing the acceptable confidence interval to 94% from 95%.

As another example, if the administrator 290 rejects the forecast 211 that failed one or more of the forecast tests, it may indicate that some or all of the forecast tests are correct. Accordingly, the forecast engine 210 may leave the forecast tests alone or may adjust the tolerances associated with the confidence interval test by decreasing the threshold percentage to 9% from 10% or by increasing the acceptable confidence interval to 96% from 95%. Other methods may be used.

The schedule engine 220 may generate a schedule 221 for one or more agents 120 and queues 125 for a plurality of intervals based on the generated forecast 211. The generated schedule 221 may assign agents 120 to queues 125 for each interval that the schedule 221 covers based on the forecast 211 such that one or more service level goals associated with each queue 125 are met. Any method for generating a schedule 221 may be used. Depending on the embodiment, the schedule engine 220 may generate schedules 221 in response to receiving a forecast 211 from the forecast engine 210.

In some embodiments, prior to generating a schedule 221, the schedule engine 220 may take certain actions to ensure that the generated schedule 221 is accurate and complete. As one example action, the schedule engine 220 may prompt one or more supervisors to identify any upcoming meetings, training, classes, or other events that will occur during the intervals covered by the schedule 221. The prompt may be an electronic communication that is sent from the schedule engine 220 to each supervisor such as an e-mail or a text message, for example.

As another example action, the schedule engine 220 may prompt agents 120 to provide any time-off requests or schedule change requests that they might have. The prompts for requests and scheduled events may be provided by the schedule engine 220 approximately one week before the schedule 221 is generated. Other time frames may be considered.

As another example action, the schedule engine 220 may interface with the contact routing system 153 to determine any new agents 120 associated with the contact center 150 as well as any agents 120 that have been terminated or are otherwise no longer associated with the contact center 150. The schedule engine 220 may further prompt the administrator 290 to update or make any changes to the work rules associated with the contact center 150 if they differ from default rules associated with the contact center 150. The interfacing and prompts for updates and changes may be made immediately prior to the schedule engine 220 generating the schedule 221.

After performing the various pre-schedule actions, the schedule engine 220 may generate the schedule 221. The schedule engine 220 may generate the schedule 221 by assigning agents 120 to queues 125 for each interval based on the amount of work predicted for each interval and queue 125 by the forecast 211 in view of the other information collected by the schedule engine 220 such as changes in the work rules or newly hired agents 120. Any method for generating a schedule 221 may be used.

After generating the schedule 221, the schedule engine 220 may perform one or more of what are referred to as schedule tests on the generated schedule 221. If the schedule 221 passes all of the schedule tests, the schedule engine 220 may release the schedule 221 to one or more of the administrator 290 and/or the agents 120.

Similar to the forecast tests, the various tests of the schedule tests may function as a sanity test to judge the reasonableness of the schedule 221. One example of such a test is the work rule violation test. During the work rule violation test it is determined if the schedule 221 causes any work rule violations for one or more agents 120. Depending on the embodiment, the contact center 150 may have one or more work rules that govern the minimum and maximum number of hours that each agent 120 may work each day or week. The work rules may further control the amount of overtime hours an agent 120 may be scheduled for. The work rules may include contact center 150 specific rules, as well as any federal, state, and local rules that the contact center 150 may be subject to due to its location.

Another example of a schedule test is the empty schedule test. The empty schedule test determines if any of the queues 125 have no staffed agents 120 for one or more intervals. As may be appreciated, it is very unlikely that a queue 125 would receive no work for an interval and therefore would need no assigned agent 120. Accordingly, the presence of an unstaffed queue 125 for an interval may be sign that there are other issues or problems with the schedule 221.

Another example of a schedule test is a surge period test that determines if there any surge periods predicted for any intervals covered by the schedule 221. Depending on the embodiment, whether or not the schedule 221 fail this test may depend on one or more tolerances related to surges. These tolerances may relate to the number of forecasted surges during the schedule 211, the total duration of all of the predicted surge periods during the schedule 221, and the relative intensity of any predicted surge periods (e.g., low vs. high). Initially tolerances may be set to one or more default values or may be specified by the administrator 290.

In the event that the generated schedule 221 does not pass all of the schedule tests, the schedule engine 220 may prompt the administrator 290 to review the generated schedule 221. The prompt may indicate all of issues with the schedule 221 that were determined from the schedule tests. The administrator 290 can reject the schedule 221, alter or modify the schedule 221, or allow the schedule 221 to be released without modification.

The actions of the administrator 290 may be used as feedback (positive or negative) to one or more of the schedule tests by the schedule engine 220. In particular, the actions may be used to adjust one or more tolerances associated with the surge rules. For example, if the administrator 290 releases the schedule 221 that failed the surge test for having too many surges, it may indicate that the tolerance related to the total number of surges that are permitted should be raised. As another example, if the administrator 290 releases the schedule 221 that failed the surge test for having a total duration of surges exceeding the tolerated duration, it may indicate that the tolerated duration should be raised.

The schedule engine 220 may further receive requests from one or more agents 120 to make changes to their work schedule. The requested change may include a request for additional time off, a shift change, or a request for an additional shift. In some embodiments, when such a request is received the schedule engine 220 may determine if the requested change will negatively impact the service level of a queue 120 for one or more intervals associated with the request.

The schedule engine 220 may further determine if the request violates any work rules or time off rule associated with the contact center 150. For example, if the request is a request for time off, the schedule engine 220 may determine whether the agent 120 will exceed their allotted amount of time off if the request is granted. If the request is a request for additional work time, the schedule engine 220 may determine whether the agent 120 will exceed their maximum shift time for the week or day if the request is granted.

The schedule engine 220 may automatically grant any received request as long as the request was not found to violate any of the work rules or negatively impact the service level of a queue 120 as described above. The schedule engine 220 may further automatically reject any received request that is found to violate any of the work rules or negatively impact the service level of a queue 120.

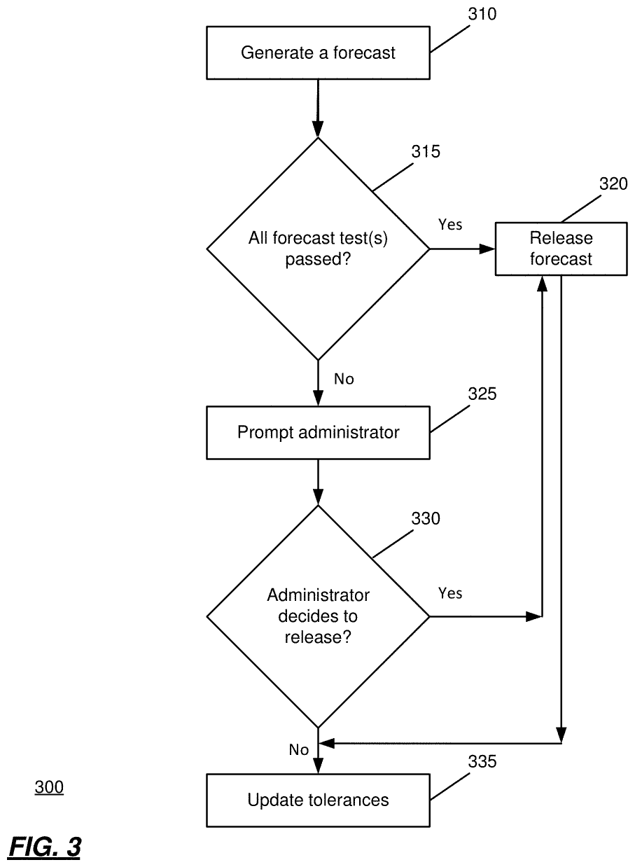

FIG. 3 is an illustration of an example method 300 for generating and releasing a forecast. The method 300 may be implemented by the configuration engine 170.

At 310, a forecast is generated. The forecast 211 may be generated by the forecast engine 210. The forecast 211 may cover a plurality of intervals for a plurality of queues 125. The forecast 211 may be generated using historical data about the number of communications handled by each queue 125 during past intervals.

At 315, whether the generated forecast passed all of the forecast tests is determined. The determination may be made by the forecast engine 210. Depending on the embodiment, the forecast tests may include determining that all queues 125 have non-zero interaction volume, handle time, and patience in the generated forecast 211. The forecast tests may further include determining if confidence intervals for each interval are within one or more tolerances. If all of the forecast tests are passed, then the method 300 may continue at 320 where the generated forecast 211 is released to one or more agents 120 and may be used by the schedule engine 220 to generate a schedule 221. If all of the forecast tests are not passed, the method 300 may continue at 325.

At 325, the administrator is prompted. The administrator 290 may be prompted by the forecast engine 210. The prompt may include information about the generated forecast 211 along with information about what aspects of the generated forecast 211 failed one or more of the forecast tests. The prompt may be in the form of an electronic communication such as an email. The prompt may include one or more links through which the administrator 290 may either approve the forecast 211 for release, may make one or more changes to the forecast 211, or may reject the generated forecast 211.

At 330, a determination of whether or not to release the generated forecast is made. The determination may be made by the administrator 290 using the links provided in the prompt. If the administrator 290 determines to release the generated forecast 211, then the method 300 may continue at 320 where the generated forecast 211 is released to one or more agents 120 and may be used by the schedule engine 220 to generate a schedule 221. After releasing the forecast 211, the method 300 may continue at 335. If the administrator determines not to release the generated forecast 211, the method 300 may continue at 335.

At 335, one or more tolerances are updated. The tolerances may be the tolerances used by one or more of the forecast tests and may be updated by the forecast engine 210. If the administrator 290 determined not to release the generated forecast 211 (i.e., the administrator 290 agreed with the forecast tests), the forecast engine 210 may update the tolerances by either maintaining the existing tolerances or increasing some or all of the tolerances such that a generated forecast 211 is more likely to fail the forecast tests.

If the administrator 290 determined to release the generated forecast 211 (i.e., the administrator 290 disagreed with the forecast tests), the forecast engine 210 may update the tolerances by decreasing some or all of the tolerances such that a generated forecast 211 is less likely to fail the forecast tests.

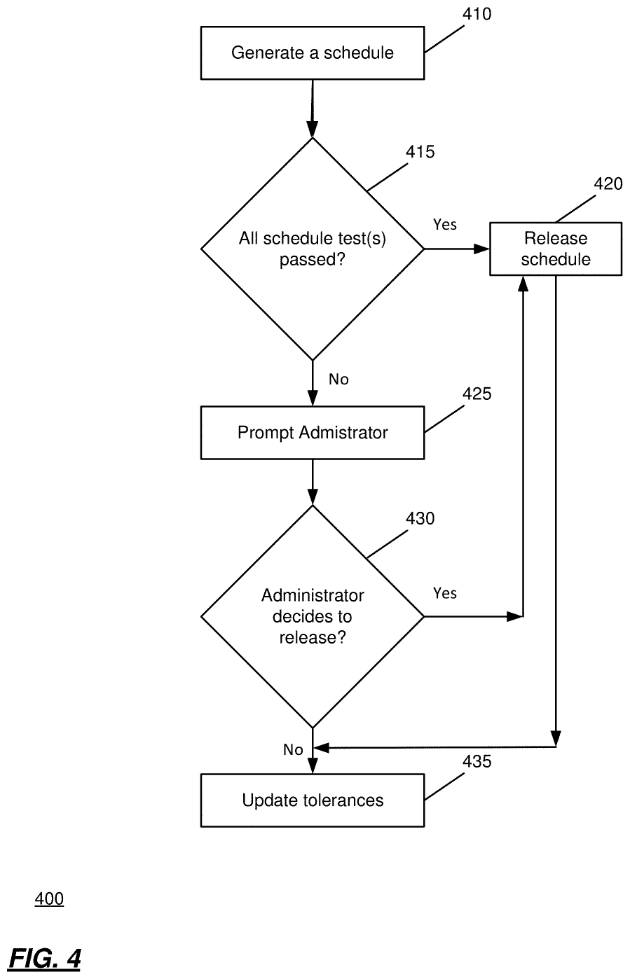

FIG. 4 is an illustration of an example method 400 for generating and releasing a schedule. The method 400 may be implemented by the configuration engine 170.

At 410, a schedule is generated. The schedule 221 may be generated by the schedule engine 220. The schedule 221 may be generated from a forecast 211 generated by the forecast engine 210. The schedule 221 may assign agents 120 to queues 125 for the intervals associated with the forecast 211.

At 415, whether the generated schedule passed all of the schedule tests is determined. The determination may be made by the schedule engine 220. Depending on the embodiment, the schedule tests may include determining if any work rules are violated by the schedule 221, determining whether any queues 125 have no assigned agents 120 for an interval, and determining if there are any surge periods predicted for the intervals associated with the schedule 221. If all of the schedule tests are passed, then the method 400 may continue at 420 where the generated forecast 211 is released to one or more agents 120. If all of the schedule tests are not passed, the method 400 may continue at 425.

At 425, the administrator is prompted. The administrator 290 may be prompted by the schedule engine 220. The prompt may include information about the generated schedule 221 along with information about what aspects of the generated schedule 221 failed one or more of the schedule tests. The prompt may be in the form of an electronic communication such as an email. The prompt may include one or more links through which the administrator 290 may either approve the schedule 221 for release, may make one or more changes to the schedule 221, or may reject the generated schedule 221.

At 430, a determination of whether or not to release the generated schedule is made. The determination may be made by the administrator 290 using the links provided in the prompt. If the administrator 290 determines to release the generated schedule 221, then the method 400 may continue at 420 where the generated schedule 221 is released to one or more agents 120. After releasing the schedule 221, the method 400 may continue at 435. If the administrator 290 determines not to release the generated schedule 221, the method 400 may continue at 435.

At 435, one or more tolerances are updated. The tolerances may be the tolerances used by one or more of the schedule tests and may be updated by the schedule engine 220 based on whether or not the administrator 290 approved or rejected the schedule 221. Depending on the embodiment, the tolerances may specifically relate to the surge period test.

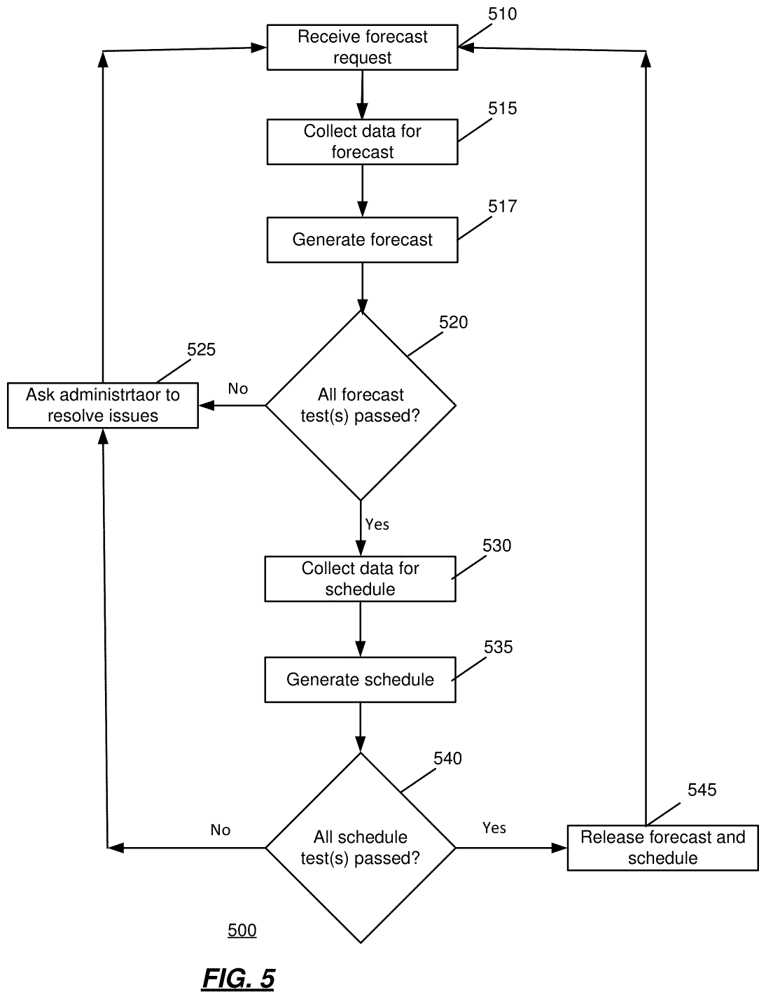

FIG. 5 is an illustration of an example method 500 for generating and releasing a forecast and a schedule. The method 500 may be implemented by the configuration engine 170.

At 510, a request to generate a forecast is received. The request may be received by the forecast engine 210. The request may be received by an administrator 290, for example.

At 515, data for the forecast is collected. The data may be collected by the forecast engine 210. The collected data may include historical data about the one or more queues 125 associated with the contact center 150. The forecast engine 210 may also prompt the administrator 290 for some or all of the data such as any upcoming marketing promotions or product releases, any upcoming holidays, any new queues 125 associated with the contact center 150, and any queues 125 that have been deleted or deactivated.

At 517, a forecast is generated. The forecast may be generated by the forecast engine 210 using the collected data. Any method for generating a forecast 211 may be used.

At 520, a determination is made as to whether the generated forecast passed all of the forecast tests. The determination may be made by the forecast engine 210. If it determined that the generated forecast 211 passed all of the forecast tests, the method 500 may continue at 530. Else, the method may continue at 525.

At 525, the administrator is asked to resolve any issues with either the forecast or the schedule. The administrator 290 may be asked by the configuration engine 170 sending an electronic message to the administrator 290 that indicates which tests were failed by either the forecast 211 or schedule 221. The administrator 290 can resolve the issues by either allowing the forecast 211 or schedule 221 to be released, not allowing the allowing the forecast 211 or schedule 221 to be released, or by modifying the forecast 211 or schedule 221 and releasing the modified forecast 211 or schedule 221.

At 530, data is collected for a schedule. The data may be collected by the schedule engine 220. The collected data may include information about new agents 120 and any agents 120 that have been terminated. The schedule engine 220 may also prompt the administrator 290 for some or all of the data such as any upcoming meetings, training, or classes that may affect the availability of agents 120. The schedule engine 220 may also prompt one or more agents 120 make any requests for time off or other schedule changes.

At 535, a schedule is generated. The schedule 221 may be generated by the schedule engine 220. The schedule 221 may be generated from the forecast 211 generated by the forecast engine 210 and any data collected at 530. The schedule 221 may assign agents 120 to queues 125 for the intervals associated with the forecast 211.

At 540, whether the generated schedule passed all of the schedule tests is determined. The determination may be made by the schedule engine 220. Depending on the embodiment, the schedule tests may include determining if any work rules are violated by the schedule 221, determining whether any queues 125 have no assigned agents 120 for an interval, and determining if there are any surge periods predicted for the intervals associated with the schedule 221. If all of the schedule tests are passed, then the method 500 may continue at 545 where the generated forecast 211 and schedule 221 are released to one or more agents 120. If all of the schedule tests are not passed, the method 500 may continue at 525 where the administrator 290 is asked to resolve as issues with the schedule 221.

After the forecast 211 and schedule 221 are released at 545 and/or any issues with the forecast 211 or schedule 221 are resolved at 525, the method 500 may return to 510 to receive another forecast request.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of tangible computer readable media. Computer readable media can be any available tangible media that can be accessed by device 600 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

Returning to FIG. 1, agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (AI), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
generating a forecast for a plurality of queues associated with an entity for a plurality of intervals by a computing device;
determining if the generated forecast passes each forecast test of a plurality of forecast tests for the plurality of queues by the computing device; and
if it is determined that the generated forecast passes the plurality of forecast tests for the plurality of queues, generating a schedule based on the generated forecast by the computing device.

2. The method of claim 1, if it is determined that the generated forecast does not pass the plurality of forecast tests, providing the generated forecast to an administrator for review.

3. The method of claim 1, wherein the plurality of forecast tests comprises one or more of an interaction volume test and a confidence interval test.

4. The method of claim 1, further comprising:
before generating the forecast:
requesting information from an administrator about one or more events that influence the forecast.

5. The method of claim 1, further comprising:
before generating the forecast:
verifying that one or more historical volumes are present.

6. The method of claim 1, further comprising:
before generating the forecast:
determining that a new queue has been added to the plurality of queues; and
in response to the new queue, requesting that an administrator identify a similar queue from the plurality of queues to the new queue.

7. The method of claim 1, further comprising:
before generating the forecast:
determining any deleted queues of the plurality of queues.

8. The method of claim 1, further comprising:
before generating the forecast:
determining if any intervals of the plurality of intervals are associated with a holiday.

9. The method of claim 1, further comprising:
receiving a request to change the schedule from an agent of the plurality of agents;
determining whether the requested change will cause the agent to violate a work rule associated with the entity; and
if it is determined that the requested change will cause the agent to violate the work rules associated with the entity, denying the request.

10. The method of claim 9, further comprising:
if it is determined that the requested change will not cause the agent to violate the work rules associated with the entity, granting the request.

11. The method of claim 1, further comprising:
receiving a request to change the schedule from an agent of the plurality of agents;
determining whether the requested change will cause a service level to be violated; and
if it is determined that the requested change will cause the service level to be violated, denying the request.

12. The method of claim 11, further comprising:
if it is determined that the requested change will not cause the service level to be violated, granting the request.

13. The method of claim 1, further comprising adjusting one or more tolerances associated with the plurality of forecast tests.

14. A system comprising:
at least one processor; and
a non-transitory computer readable medium comprising instructions that, when executed by the at least one processor, cause the system to:
generate a forecast for a plurality of queues associated with an entity for a plurality of intervals;
determine if the generated forecast passes each forecast test of a plurality of forecast tests for the plurality of queues; and
if it is determined that the generated forecast passes the plurality of forecast tests for the plurality of queues, generate a schedule based on the generated forecast.

15. The system of claim 14, if it is determined that the generated forecast does not pass the plurality of forecast tests, providing the generated forecast to an administrator for review.

16. The system of claim 14, wherein the plurality of forecast tests comprises one or more of an interaction volume test and a confidence interval test.

17. The system of claim 14, further comprising instructions that, when executed by the at least one processor, cause the system to:
before generating the forecast:
request information from an administrator about one or more events that influence the forecast.

18. The system of claim 14, further comprising instructions that, when executed by the at least one processor, cause the system to:
before generating the forecast:
verify that one or more historical volumes are present.

19. The system of claim 14, further comprising instructions that, when executed by the at least one processor, cause the system to:
before generating the forecast:
determine that a new queue has been added to the plurality of queues; and
in response to the new queue, request that an administrator identify a similar queue from the plurality of queues to the new queue.

20. A non-transitory computer readable medium comprising instructions that, when executed by at least one processor, cause a computer system to:
generate a forecast for a plurality of queues associated with an entity for a plurality of intervals;
determine if the generated forecast passes each forecast test of a plurality of forecast tests for the plurality of queues; and
if it is determined that the generated forecast passes the plurality of forecast tests for the plurality of queues, generate a schedule based on the generated forecast.
